(19) United States
(12) Patent Application Publication
(10) Pub. No.: US 2019/0245608 A1
(43) Pub. Date: Aug. 8, 2019

(54) METHOD OF CONSTRUCTING CODEBOOK WITH MULTIPLE RESOLUTION AND USER EQUIPMENT

(71) Applicant: NTT DOCOMO, INC., Tokyo (JP)

(72) Inventors: Yuichi Kakishima, Tokyo (JP); Chongning Na, Tokyo (JP); Huiling Li, Tokyo (JP); Huiling Jiang, Tokyo (JP); Satoshi Nagata, Tokyo (JP)

(73) Assignee: NTT DOCOMO, INC., Tokyo (JP)

(21) Appl. No.: 16/345,181

(22) PCT Filed: Oct. 25, 2017
(86) PCT No.: PCT/US2017/058299

§ 371 Date: Apr. 25, 2019

Related U.S. Application Data
(60) Provisional application No. 62/412,629, filed on Oct. 25, 2016.

(51) Int. Cl. H04B 7/06; H04B 7/0456; H04B 7/0417; H04W 88/02

(52) U.S. Cl. CPC H04B 7/0695; H04B 7/0626; H04W 88/02; H04B 7/0478; H04B 7/0417; H04B 7/0617

(57) ABSTRACT

A method of constructing a codebook with multiple resolution in a wireless communication system includes constructing, with a user equipment (UE), a high resolution codebook using a low resolution codebook; and transmitting, from the UE to a base station (BS), Channel State Information (CSI) feedback in accordance with a feedback scheme corresponding to the high resolution codebook or the low resolution codebook. The high resolution codebook defines the feedback scheme corresponding to the high resolution codebook. The method further comprises selecting, with the UE, multiple first beams from multiple second beams used for downlink transmission from the BS. The constructing constructs the high resolution codebook based on the multiple first beams, and the low resolution codebook is constructed based on a single beam selection scheme that selects a single beam.

### TECHNICAL FIELD

The present invention generally relates to a method of constructing a codebook with multiple resolution, and a user equipment in a wireless communication system.

### BACKGROUND ART

A New Radio (NR; fifth generation (5G) radio access technology) system operates in higher frequency bands (e.g., Millimeter Wave (mmWave)). In the NR system using the mmWave, transmission and reception beam selection greatly affects system characteristics.

In the NR system, transmission and reception beams are determined using beam management and channel state information (CSI) acquisition. Typically, a long-term (periodic) and wideband beam may be determined in the beam management, and then, a short-term (triggered) and narrow band beam may be determined in the CSI acquisition scheme.

In the 3rd Generation Partnership Project (3GPP) Radio Access Network (RAN) Working Group (WG), it is agreed that two types of codebook design are used in the CSI acquisition. One is a low resolution codebook which is constructed by a single beam selection scheme. In the single beam selection scheme, a single beam is selected from multiple beams. The other is a high resolution codebook which is constructed by a beams combination scheme. In the beams combination scheme, a combination of at least two beams is selected from multiple beams. CSI reporting for the beams combination scheme is called advanced CSI reporting.

Conventional methods of constructing the high resolution codebook is not compatible to a LTE codebook or do not allow the reuse of the legacy LTE codebook, with either non-orthogonal or constrained DFT beams. Thus, how the high resolution codebook should be constructed has not been determined in the 3GPP RAN WG. Furthermore, how CSI feedback design for the normal CSI reporting and the advanced CSI reporting has not been determined.

### NON-PATENT REFERENCE

[Non-Patent Reference 1] 3GPP, TS 36.211 V 14.4.0
[Non-Patent Reference 2] 3GPP, TS 36.213 V 14.4.0

### SUMMARY OF THE INVENTION

One or more embodiments of the present invention relate to a method of constructing a codebook with multiple resolution in a wireless communication system that includes constructing, with a user equipment (UE), a high resolution codebook using a low resolution codebook, and transmitting, from the UE to a base station (BS), Channel State Information (CSI) feedback in accordance with a feedback scheme corresponding to the high resolution codebook or the low resolution codebook.

One or more embodiments of the present invention relate to a user equipment (UE) including a processor that constructs a high resolution codebook using a low resolution codebook and a transmitter that transmits, to a base station (BS), Channel State Information (CSI) feedback in accordance with a feedback scheme corresponding to the high resolution codebook or the low resolution codebook.

Other embodiments and advantages of the present invention will be recognized from the description and figures.

### BRIEF DESCRIPTION OF THE DRAWINGS

FIG. 1 is a diagram showing a configuration of a wireless communication system according to one or more embodiments of the present invention.

FIG. 2A is a diagram to explain a low (normal) resolution codebook according to one or more embodiments of the present invention.

FIG. 2B is a diagram to explain a high resolution codebook according to one or more embodiments of the present invention.

FIGS. 3A and 3B are diagrams showing an example of a method of selecting high resolution beams according to one or more embodiments of a first example of the present invention.

FIGS. 4A and 4B are diagrams showing an example of a method of selecting high resolution beams according to one or more embodiments of a second example of the present invention.

FIG. 5 is a diagram showing an example of a method of selecting high resolution beams according to one or more embodiments of a third example of the present invention.

FIG. 6 shows an example of a formula used for codebook construction electing high resolution beams according to one or more embodiments of the present invention.

FIG. 7 is a diagram showing an example of normal CSI reporting triggered by a BS according to one or more embodiments of a fourth example or another example of the present invention.

FIG. 8 is a diagram showing an example of advanced CSI reporting triggered by a BS according to one or more embodiments of a fourth example or another example of the present invention.

FIG. 9 is a diagram showing an example of advanced CSI reporting triggered by a UE according to one or more embodiments of a fifth example of the present invention.

FIG. 10 is a diagram showing an example of CSI feedback timeline according to one or more embodiments of a sixth example of the present invention.

FIG. 11 is a diagram showing an example of RI indication according to one or more embodiments of a seventh example of the present invention.

### DETAILED DESCRIPTION OF EMBODIMENTS

Embodiments of the present invention will be described in detail below, with reference to the drawings. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

In one or more embodiments of the present invention, a low resolution codebook may be referred to as a normal resolution codebook, or a Type I codebook and a high resolution codebook may be referred to as an advanced codebook or a Type II codebook. In one or more embodiments of the present invention, low resolution CSI and low resolution (CSI) feedback may be referred to as normal resolution CSI and normal resolution (CSI) feedback, respectively. Thus, in one or more embodiments of the present invention, “low resolution” may be referred to as “normal resolution.”

In one or more embodiments of the present invention, normal CSI may be CSI generated using the low resolution codebook and advanced CSI may be CSI generated using the high resolution codebook.

In one or more embodiments of the present invention, in a normal CSI feedback scheme, the normal CSI is reported from a user equipment (UE) to a base station (BS) as feedback information (normal CSI reporting). In one or more embodiments of the present invention, in an advanced CSI feedback scheme, the advanced CSI is reported from the UE to the BS as feedback information (advanced CSI reporting).

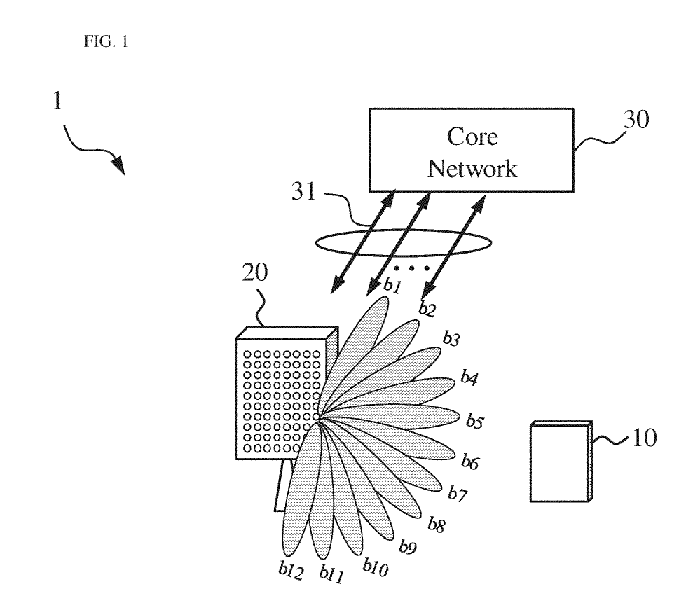

FIG. 1 is a wireless communications system 1 according to one or more embodiments of the present invention. The wireless communication system 1 includes a UE 10, a BS 20, and a core network 30. The wireless communication system 1 may be a New Radio (NR) system or an LTE/LTE-Advanced (LTE-A) system. The wireless communication system 1 is not limited to the specific configurations described herein and may be any type of wireless communication system.

The BS 20 may communicate uplink (UL) and downlink (DL) signals with the UE 10 in a cell of the BS 20. The DL and UL signals may include control information and user data. The BS 20 may communicate DL and UL signals with the core network 30 through backhaul links 31. The BS 20 may be an example of a base station (BS). The BS 20 may be referred to as a TRP. The BS 20 may be a gNodeB (gNB) for the NR system or an evolved NodeB (eNB) for the LTE/LTE-Advanced (LTE-A) system.

The BS 20 includes antennas, a communication interface to communicate with an adjacent BS 20 (for example, X2 interface), a communication interface to communicate with the core network 30 (for example, Si interface), and a CPU (Central Processing Unit) such as a processor or a circuit to process transmitted and received signals with the UE 10. Operations of the BS 20 may be implemented by the processor processing or executing data and programs stored in a memory. However, the BS 20 is not limited to the hardware configuration set forth above and may be realized by other appropriate hardware configurations as understood by those of ordinary skill in the art. Numerous BSs 20 may be disposed so as to cover a broader service area of the wireless communication system 1.

The UE 10 may communicate DL and UL signals that include control information and user data with the BS 20 using Multi Input Multi Output (MIMO) technology. The UE 10 may be a mobile station, a smartphone, a cellular phone, a tablet, a mobile router, or information processing apparatus having a radio communication function such as a wearable device. The wireless communication system 1 may include one or more UEs 10.

The UE 10 includes a CPU such as a processor, a RAM (Random Access Memory), a flash memory, and a radio communication device to transmit/receive radio signals to/from the BS 20 and the UE 10. For example, operations of the UE 10 described below may be implemented by the CPU processing or executing data and programs stored in a memory. However, the UE 10 is not limited to the hardware configuration set forth above and may be configured with, e.g., a circuit to achieve the processing described below.

In one or more embodiments of the present invention, beam selection may be performed in the wireless communication system 1. For example, in a beam selection scheme, as shown in FIG. 1, the BS 20 may transmit multiple Channel State Information Reference Signals (CSI-RSs) using multiple beams b1-b12 to the UE 10. The UE 10 may perform channel estimation based on the received multiple CSI-RSs. Then, the UE 10 may select, from codebooks indicating candidates of precoding weights, at least a precoding weight. The UE 10 also selects at least beam based on a result of the channel estimation. The UE 10 may transmit, to the BS 20, feedback information including at least one of a Channel Quality Indicator(s) (RI(s)), a Precoding Matrix Indicator(s) (PMI(s)), a Rank Indicator(s) (RI(s)), and a CSI-RS Resource Index(es) (CRI(s)) (or Beam Index(es)). The CQI indicates channel quality state. The PMI indicates an index of the precoding weight(s). The RI indicates channel spatial freedom for DL transmission. The CRI identifies each of the beams. The UE 10 can report all the parameters or report partial of the parameters, e.g., RI, PMI and CQI. The BS 20 may transmit a signal(s) precoded based on the feedback information to the UE 10. If the feedback information includes the CRI, the BS 20 may transmit the precoded signal(s) using the selected beam(s).

(Codebook Design)

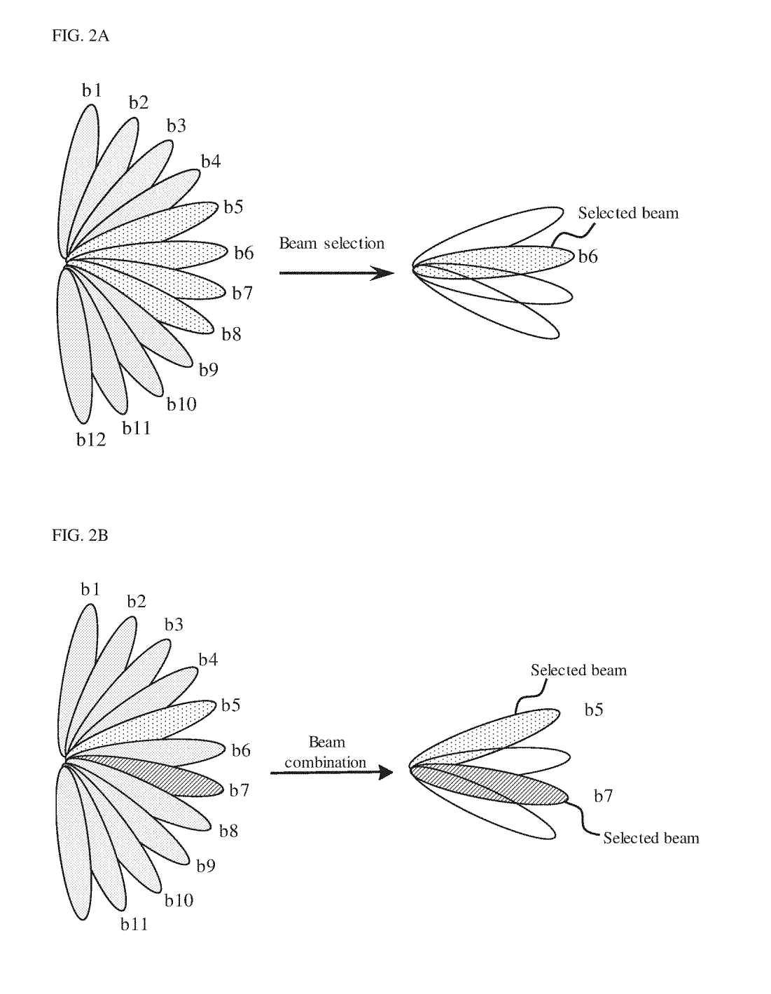

In one or more embodiments of the present invention, a low resolution codebook may be constructed based on a single beam selection scheme as shown in FIG. 2A. On the other hand, in one or more embodiments of the present invention, a high resolution codebook is constructed based on a beams combination scheme as shown in FIG. 2B. In an example of FIG. 2B, two beams b5 and b7 for a combination are selected in the beams combination scheme. In one or embodiments of the present invention, a beam(s) used to construct the high resolution codebook is referred to as a high resolution beam(s).

In the 3GPP standard, how to construct the high resolution codebook is not determined. For example, how to select beams for a combination to construct the high resolution codebook.

One or more embodiments of the present invention provides a method of constructing a high resolution codebook. For example, high resolution beams to construct the high resolution codebook may be selected based on reuse of LTE Rel. 13 beams.

According to one or more embodiments of the present invention, a low resolution codebook and a high resolution codebook may use a common part for a beam selection scheme. The same for normal CSI and advanced CSI, which helps to reduce calculation complexity and feedback overhead.

According to one or more embodiments of the present invention, if a rank 1 codebook is used for the normal CSI, advanced CSI leading beam may be the same with a rank 1, CF 1 beam. In addition to the leading beam, combined beam(s) may be selected from beams that are orthogonal to the leading beam.

According to one or more embodiments of the present invention, if rank 3 codebook is used for the normal CSI, the advanced CSI leading beam is the same with the rank 3, CF 1 beam. The combined beam is the other beam within rank 3 codebook beam group or the combined beams are selected freely from beams that are orthogonal to the leading beam.

### First Example

According to one or more embodiments of a first example of the present invention, high resolution beams to construct the high resolution codebook may be selected based on reuse of configure (CF) 1 beams. For example, in one or more embodiments of a first example of the present invention, high resolution beams including a leading beam and combined beams may be selected for constructing the high resolution codebook.

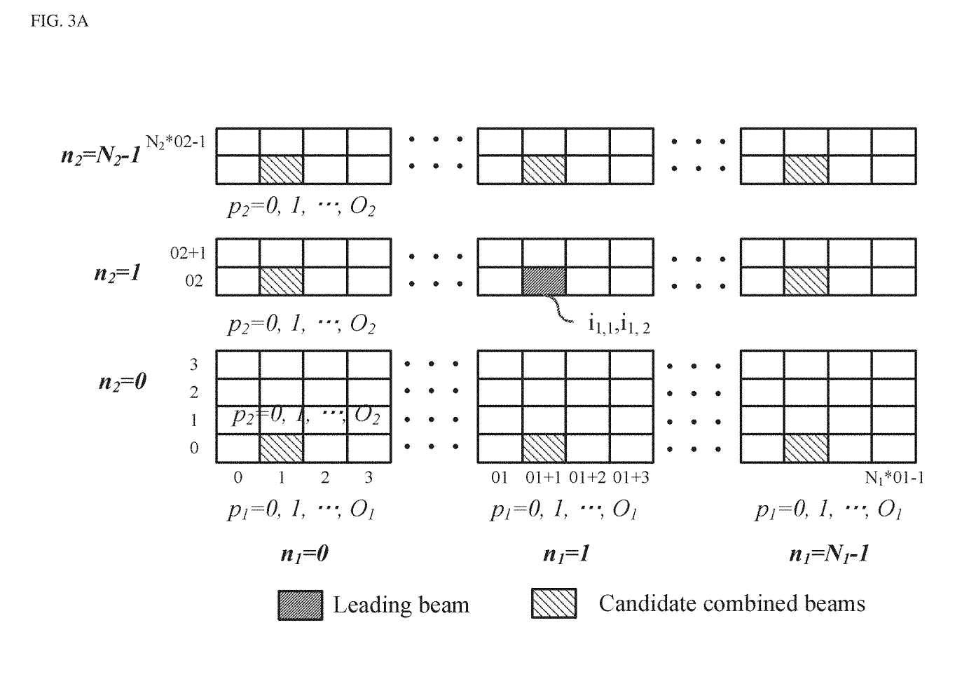

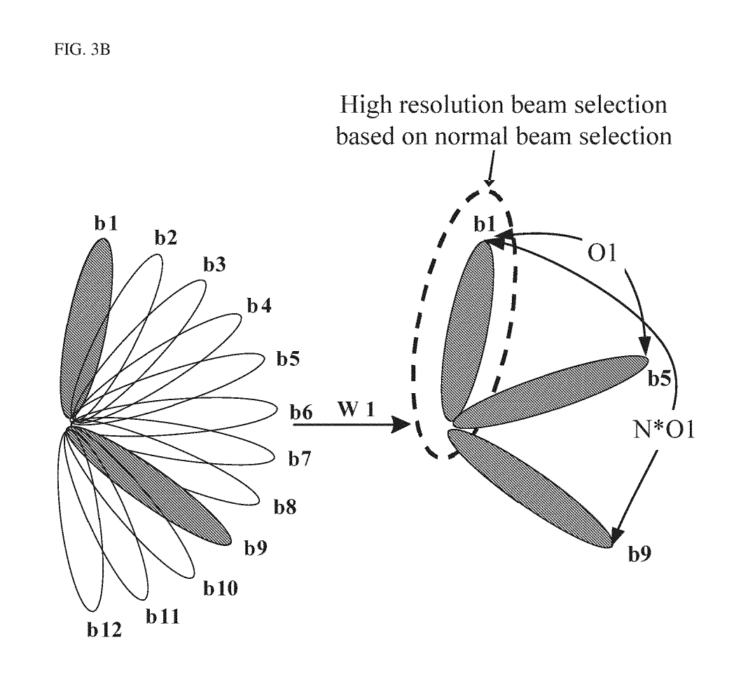

FIGS. 3A and 3B show an example of a method of selecting high resolution beams according to one or more embodiments of the first example of the present invention. In one or more embodiments of the first example of the present invention, the selected high resolution beams may be determined based on an unconstrained beam combination (group) by LTE Rel.13 rank 1 beams (codewords) in accordance with a rank 1 beam selection scheme.

As can be seen in FIG. 3A, each single grid represents one two-dimension (2D) Discrete Fourier Transform (DFT) vector indicating beam rotation. The DFT vector constitutes to a pre-coder used for beamforming. The whole grids represent all possible beams. In FIG. 3A, a horizontal axis and a vertical axis represent a horizontal direction and a vertical direction, respectively. O represents an oversampling factor. O1 and O2 indicate the oversampling factors in the horizontal direction and the vertical direction, respectively. N1 and N2 represent an antenna ports number in a first dimension and a second dimension, respectively. As those skilled in the art will readily appreciate, all of the specific dimensions can be changed without departing from the spirit of one or more embodiments of the present invention.

If a beam is at a distance of n₁*O₁+n₂*O₂(n₁=1, 2, . . . , N₁−1, n2=1, 2, . . . N₂−1) from the reference beam, the beam is orthogonal to the reference beam. All of the beams may be divided into N₁*N₂ beam groups. Each beam group is identified by index n₁, n₂. The size of one beam group is O₁*O₂. Another parameter p may be defined as an index of the DFT vector (beam rotation index) within a group. Thus, p1 is the DFT vector index in the first dimension and p₂ is the DFT vector index in the second dimension. In one beam group, each beam may be identified by p₁, p₂. p₁=0, 1, . . . O₁−1, p₂=0, 1, . . . O₂−1. The beam group is divided such that the beam p₁, p₂ in beam group a is orthogonal to the beam pₕ p₂ in beam group b.

Next, i_{1,1}, i_{1, 2} in FIG. 3A may be defined to represent an absolute index of each beam in the entire grids. The definition of i_{1,1}, i_{1,2} can be found in 3GPP TS 36.213, Section 7.2.4, Table 7.2.4-10. i_{1,1}=p₁+n₁*O₁, i_{1,2}=p₂+n₂*O₂. The index of one beam may be represented by parameter p₁, p₂, n₁, n₂, O₁, O₂, N₁, N₂.

A high resolution beam construction process according to one or more embodiments of the first example of the present invention will be described below. In the LTE system, only one beam (e.g., i_{1,1}, i_{1,2}) is selected to construct a low resolution codebook for LTE. On the other hand, for high resolution feedback, K orthogonal beams may be selected to construct the high resolution codebook.

According to one or more embodiments of the first example of the present invention, among the K orthogonal beams, a leading beam may be selected according to the legacy codebook W1, which corresponds to the one beam for normal CSI reporting. As shown in FIG. 3A, the leading beam may be selected by i_{1,1}, and i_{1,2}, which can be derived by p₁, p₂ and n₁(1), n₂(1), that is, i_{1,1}(i)=p₁+n₁(i)*O₁ and i_{1,2}(i)=p₂+n₂(i)*O₂. The combined beams may be fixed by n₁(k), n₂(k), k∈{2, . . . , K}, where K is the total number of combined beams, which indicates which the orthogonal beam is selected. In an example of FIG. 3B, when the candidate combined beams are beams b1 and b9, beam b5 is selected as the leading beam using the legacy codebook W1.

In order to reuse the legacy codebook W1 and the legacy feedback scheme, the definition of i_{1,1}, i_{1,2} are identical to those used for legacy codebook, e.g., in 3GPP TS 36.213, Section 7.2.4, Table 7.2.4-10. The other K−1 candidate combined beams are those at distance of n₁*O₁+n₂*O₂.

In a CSI feedback scheme, the normal CSI includes the RI, a leading beam index and the CQI. On the other hand, in one or more embodiments of the present invention, an advanced CSI includes, in addition to the normal CSI, K−1 combined beam indexes, the amplitude and co-phase of the combined beams, if any. Advanced CSI reporting includes the RI and the CQI. For advanced CSI reporting, index of the combined beam k be n₁(k), n₂(k) instead of i_{1,1}(k), i_{1,2}(k) to reduce feedback overhead.

For a beam index encoding scheme according to one or more embodiments of the first example of the present invention, the leading beam index and the combined beam index may be determined based on joint coding of the DFT vector index (rotation index). For example, the leading beam index may be determined as i_{1,1}(1)=p₁+n₁(1)*O₁, i_{1,2}(1)=p₂+n₂(1)*O₂. The combined beam index may be determined as n₁(2), n₂(2), . . . n₁(K), n₂(K), where K is the total number of beams. In the BS 20, it can infer the combined beam index by: i_{1,1}(k)=mod(i_{1,1}(1), O₁)+n₁(k)*O₁ and i_{1,2}(k)=mod(i_{1,2}(1), O₂)+n₂(k)*O₂. Thus, feedback of the leading beam index can be performed based on the legacy LTE codebook and can reuse the legacy LTE feedback, because the definition of i_{1,1}(1) and i_{1,2}(1) is identical to those defined for the legacy LTE feedback of 1-layer codebook, as seen in 3GPP TS 36.213, Section 7.2.4, Table 7.2.4-10.

As another example of the beam index encoding scheme, the independent DFT vector index (rotation index) may be determined as p₁, p₂ and the beam index for each beam may be determined as n₁(1), n₂(1) [leading beam], n₁(2), n2(2), . . . , n₁(K), n₂(K). In the BS 20, it can infer the combined beam index by: i_{1,1}(k)=p₁+n₁(k)*O₁ and i_{1,2}(k)=p₂+n₂(k)*O₂.

If the advanced CSI reporting is configured, additional information will be reporting. The additional beam index and weightings are scaled refer to the leading beam reported in the normal CSI reporting. If there is no additional information, the BS 20 will use normal CSI feedback.

Thus, according to one or more embodiments of the present invention, the high resolution beams may be selected based on the rank 1 beam selection scheme of the LTE standard. According to one or more embodiments of the first example of the present invention, the high resolution codebook reuses the rank 1 beam selection scheme when beam selection of the rank 1 beam selection scheme has no group constrain.

### Second Example

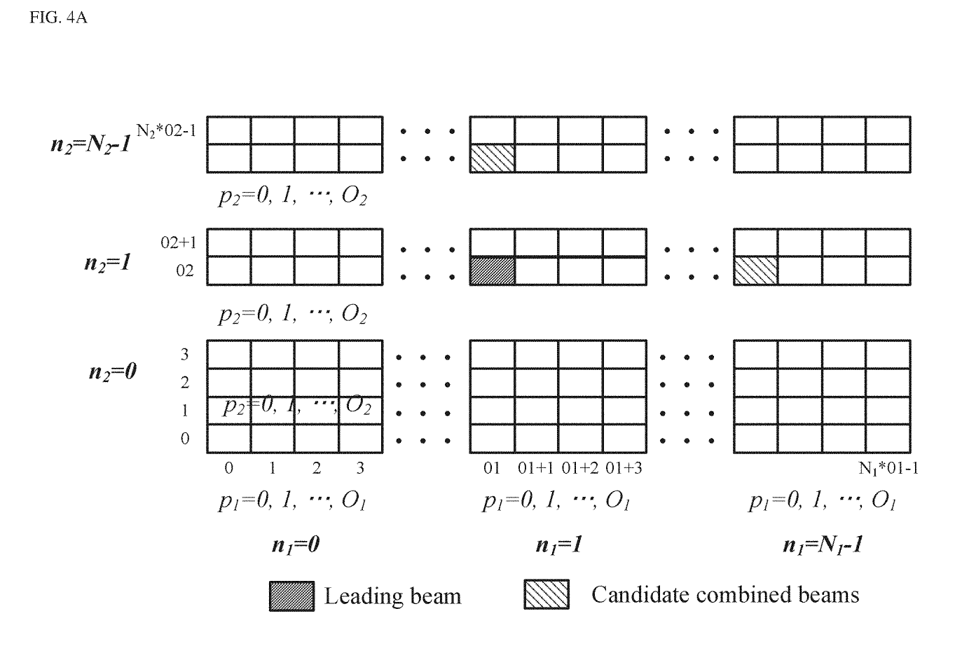

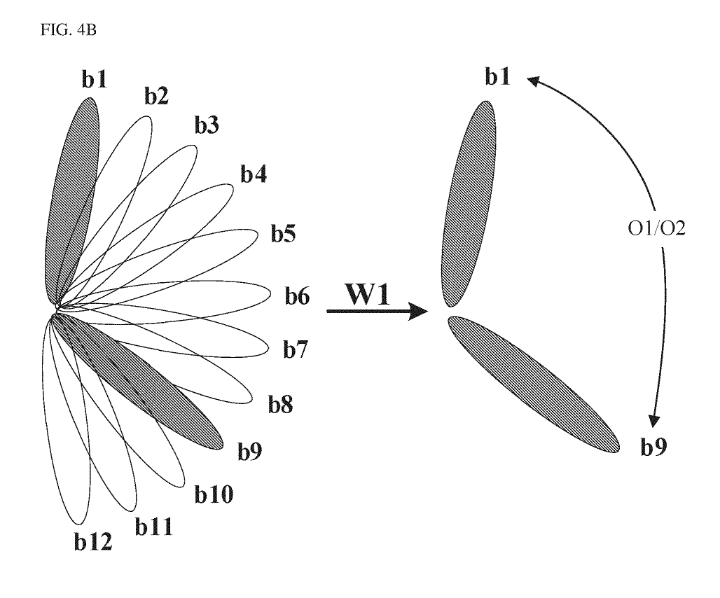

According to one or more embodiments of a second example of the present invention, high resolution beams to construct the high resolution codebook may be selected based on a constrained beam combination (group) by LTE Rel.13 rank 3 beams. FIGS. 4A and 4B show an example of a method of selecting high resolution beams according to one or more embodiments of the second example of the present invention.

In rank 3 codebook design, one beam group is selected, from one or more beam groups where beams are orthogonal to each other, as the beam index i_{1,1}, i_{1,2}. Therefore, both of the leading beam and the combined beam(s) may be selected as the beam index i_{1,1}, i_{1,2}.

To utilize the characteristic of the orthogonality between beams and to reduce feedback overhead, the high resolution codebook according to one or more embodiments of the second example of the present invention may directly use the beam group used for the rank 3 codebook. As a result, for feedback of the beam index indicating the selected beam, only the beam index i_{1,1}, i_{1,2} is needed, while a method using the unconstrained beam selection needs feedback of the combined beam index.

For example, in one or more embodiments of the second example of the present invention, in addition to the beams that already involved in the rank 3 codebook, more orthogonal beams may be selected in the high resolution codebook.

FIGS. 4A and 4B show an example of a method of selecting high resolution beams according to one or more embodiments of the second example of the present invention. FIGS. 4A and 4B show an example relating to a constrained beam combination based on the LTE Rel.13 rank 3 codebook.

According to one or more embodiments of the second example of the present invention, there is a fixed space between the combined beam and the leading beam and the space may be determined based on the legacy LTE 3-layer codebook. The leading beam index (e.g., i_{1,1}, i_{1,2}) and the legacy codebook index (e.g., i′_{1,1}, and i′_{1,2}) may be determined as follows:

i_{1,1}=mod(i′_{1,1},N₁*O₁);

i_{1,2}=i′_{1,2},

where the definition of i′_{1,1} and i′_{1,2} is identical to the definition of i_{1,1}, and i_{1,2} for the legacy LTE feedback of 3-layer codebook, as seen in 3GPP TS 36.213, Section 7.2.4, Table 7.2.4-12.

If floor(i′_{1,1}/(N₁*O₁))=0, the combined beam is

i_{1,1}(2)=i_{1,1}(1)+O₁; and

i_{1,2}(2)=i_{1,2}(1).

If floor(i′_{1,1}/(N₁*O₁))=1, the combined beam is

i_{1,1}(2)=i_{1,1}(1),

i_{1,2}(2)=i_{1,2}(1)+O₂.

Thus, according to one or more embodiments of the second example of the present invention, the highest resolution beams may be selected based on the rank 3 beam selection scheme of the LTE standard. According to one or more embodiments of the second example of the present invention, the low resolution codebook may reuse the rank 3 beam selection scheme when beam selection of the rank 3 beam selection scheme has group constrain.

### Third Example

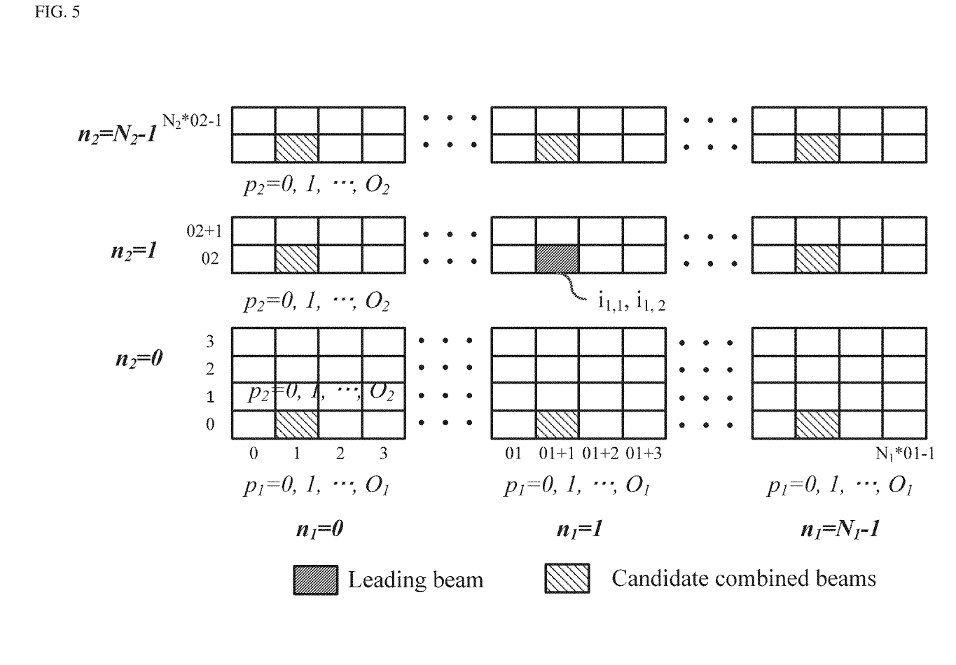

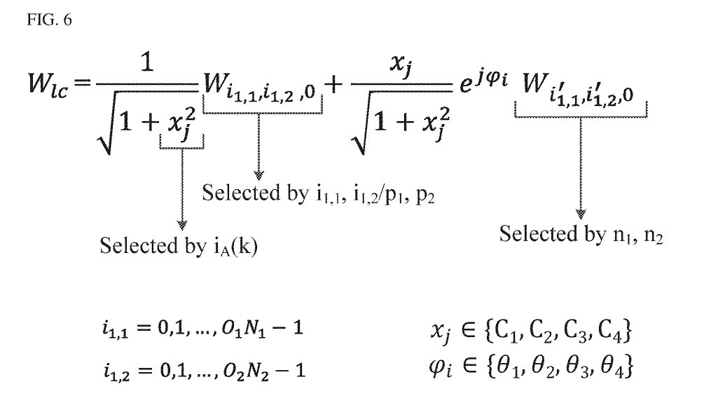

According to one or more embodiments of a third example of the present invention, high resolution beams to construct the high resolution codebook may be selected based on an unconstrained beam combination (group) by LTE Rel.13 rank 3 beams. FIG. 5 shows an example of a method of selecting high resolution beams according to one or more embodiments of the second example of the present invention.

According to one or more embodiments of the third example of the present invention, the leading beam index and the combined beam index may be determined based on joint coding of the DFT vector index (rotation index).

As another example, the leading beam index and the combined beam index may be determined based on independent DFT vector index (rotation index) and beam index.

In one or more embodiments of the third example of the present invention,

There are differences in connection of the leading beam index (e.g., i_{1,1}, i_{1,2}) and the legacy codebook index (e.g., i′_{1,1}, and i′₁₂).

i_{1,1}=mod(i′1,1,N1*O1); and

i_{1,2}=i′_{1,2},

where the definition of i′_{1,1}, and i′_{1,2} is identical to the definition of i_{1,1}, and i_{1,2} for the legacy LTE feedback of 3-layer codebook, as seen in 3GPP TS 36.213, Section 7.2.4, Table 7.2.4-12.

There are differences in a range of i_{1,1}. i_{1,2}, and the derivation of the index in the UE 10 is as follows:

n₁=(i_{1,1} mod(N₁*O₁))/O₁; and

n₂=(i_{1,2} mod(N₂*O₂))/O₂.

(Codebook Construction)

The codebook according to one or more embodiments of the present invention may be constructed based on the formula as shown in FIG. 6. In the formula, xⱼ is beam power for combined beam(s) and φᵢ is a phase between beams.

During feedback, the leading beam index is represented by i_{1,1}, i_{1,2}, the combined beam index is represented by i_{1,1}, wherein i_{1,1} and i_{1,2} is calculated by: i_{1,1}(i)=p₁+n₁(i)*O₁^{and} i_{1,2}(i)=p₂+n₂(i)*O₂; i_{1,1′} and i_{1,2′} is represented by n1,n2; xⱼ is represented by i_{A}(k); φᵢ is included in i₂(PMI2).

Thus, according to one or more embodiments of the second example of the present invention, the highest resolution beams may be selected based on the rank 3 beam selection scheme of the LTE standard. According to one or more embodiments of the third example of the present invention, the low resolution codebook may reuse the rank 3 beam selection scheme when beam selection of the rank 3 beam selection scheme has no group constrain.

As explained above, according to one or more embodiments of the present invention, the high resolution codebook may be constructed by the UE 10 using the low resolution codebook. Furthermore, the UE 10 may transmit, to the BS 20, the CSI feedback in accordance with a feedback scheme corresponding to the high resolution codebook or the low resolution codebook.

In one or more embodiments of the present invention, the high resolution codebook may define the CSI feedback scheme corresponding to the high resolution codebook.

According to one or more embodiments of the present invention selecting, the BS 20 may transmit the DL signals using multiple beams. The UE 10 may select the leading beam(s) and the combined beams (multiple first beams) from the multiple beams (multiple second beams) used for the DL transmission from the BS 20. The UE 10 may construct the high resolution codebook based on the leading beam(s) and the combined beams (multiple first beams). The low resolution codebook may be constructed based on a single beam selection scheme that selects a single beam.

According to one or more embodiments of the present invention, the leading beam(s) and the combined beams (multiple first beams) based on the low resolution codebook.

According to one or more embodiments of the present invention, the high resolution codebook may reuse a legacy rank 1 beam selection scheme or a rank 3 beam selection scheme.

(CSI Feedback Design)

There are a normal CSI feedback scheme and an advanced CSI feedback scheme as CSI feedback types.

In the normal CSI feedback scheme, the normal CSI includes a beam index of a single beam, which is selected using the low resolution codebook. The normal CSI reporting is performed based on part of the codebooks with a limited CSI feedback overhead.

In the advanced CSI feedback scheme, the advanced CSI includes the leading beam(s) and the combined beam(s), which are selected using the high resolution codebook. The advanced CSI reporting is performed based on the full codebooks with a larger CSI feedback overhead.

Thus, a codebook design enables flexible tradeoff between channel quantization accuracy and a CSI feedback overhead.

From reporting point of view, normal Channel State Information (CSI) reporting and advanced CSI reporting share common codebook. As the normal (low) resolution codebook part is constructed based on the legacy codebook, it fully follows the legacy feedback framework, and it achieves a good compatibility with the legacy UE, which can only support legacy codebook.

In the conventional technologies, how to select the CSI feedback type has not been determined. According to one or more embodiments of the present invention, the CSI feedback type may be selected by the BS 20 or the UE 10.

### Fourth Example

According to one or more embodiments of a fourth example of the present invention, the CSI feedback type may be configured by the BS 20 in Radio Resource Control (RRC) signaling. Thus, the BS 20 may transmit information indicating the CSI feedback type (normal CSI reporting or advanced CSI reporting) using the RRC signaling. In such a method, the timeline for feedback is clear on the BS 20 and the UE 10.

According to one or more embodiments of another example of the fourth example of the present invention, the CSI feedback type may be configured by the BS 20 in Downlink Control Information (DCI). Thus, the BS 20 may transmit information indicating the CSI feedback type (normal CSI reporting or advanced CSI reporting) using the DCI. In such a method, the timeline for feedback is clear on the BS 20 and the UE 10.

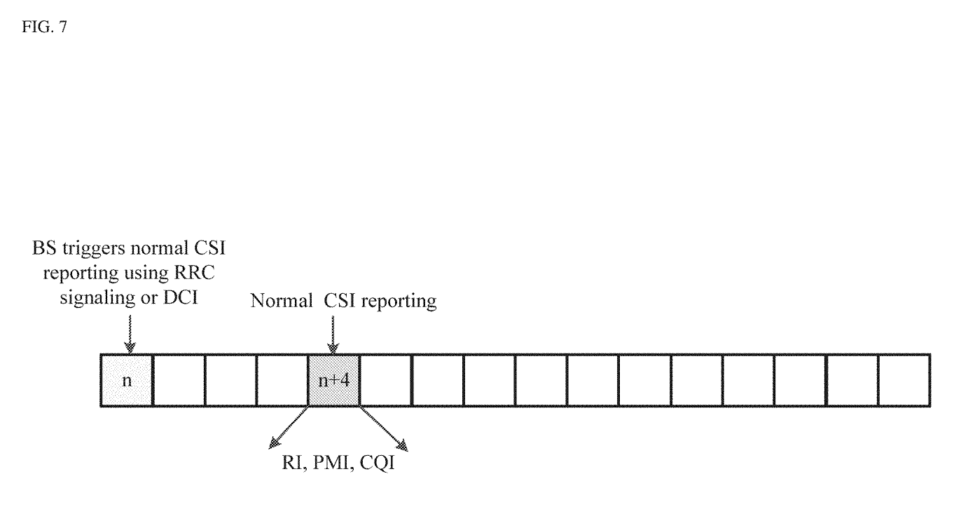

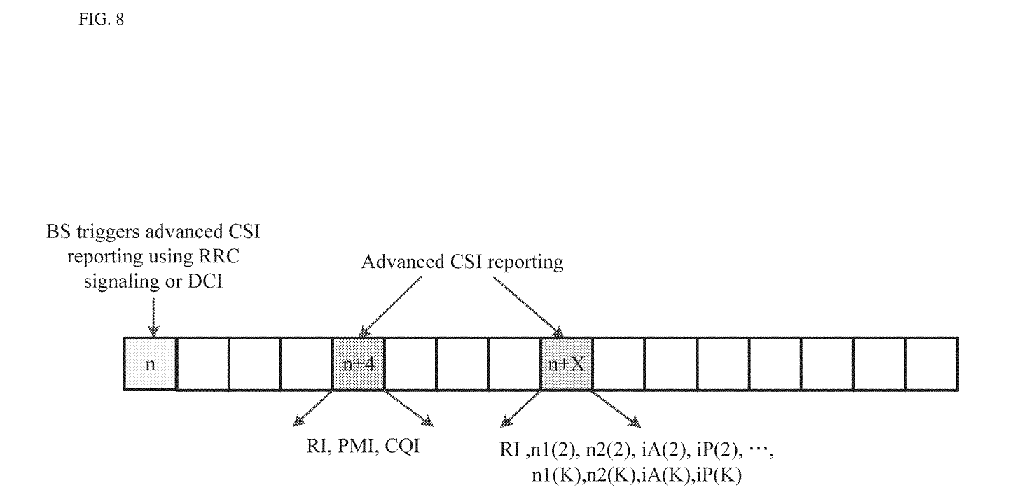

FIG. 7 shows an example of the normal CSI reporting triggered by the BS 20 using the RRC signaling (or DCI). In FIG. 7, when the UE 10 receives a trigger of the normal CSI reporting on subframe “n,” the normal CSI reporting may be performed on subframe “n+4.” Furthermore, 4 milliseconds (ms) can be extended to longer interval, e.g., 5, 6, . . . , 10 ms to give the UE 10 sufficient time to calculate contents of the high resolution feedback.

FIG. 8 shows an example of the advanced CSI reporting triggered by the BS 20 using the RRC signaling (or DCI). In FIG. 7, when the UE 10 receives a trigger of the advanced CSI reporting on subframe “n,” the normal CSI reporting may be performed on subframes “n+4” and “n+X.”

### Fifth Example

According to one or more embodiments of a fifth example of the present invention, the CSI feedback type may be selected by the UE 10.

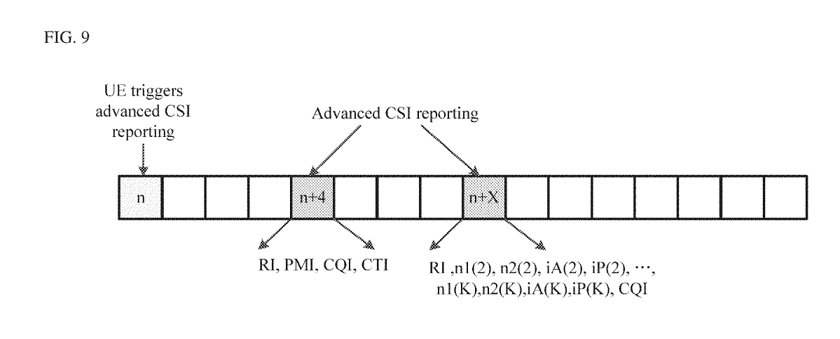

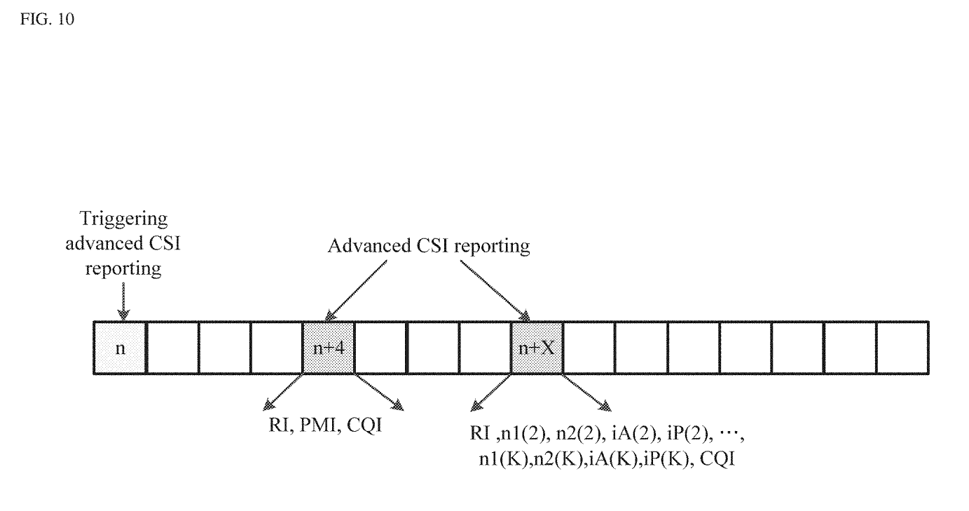

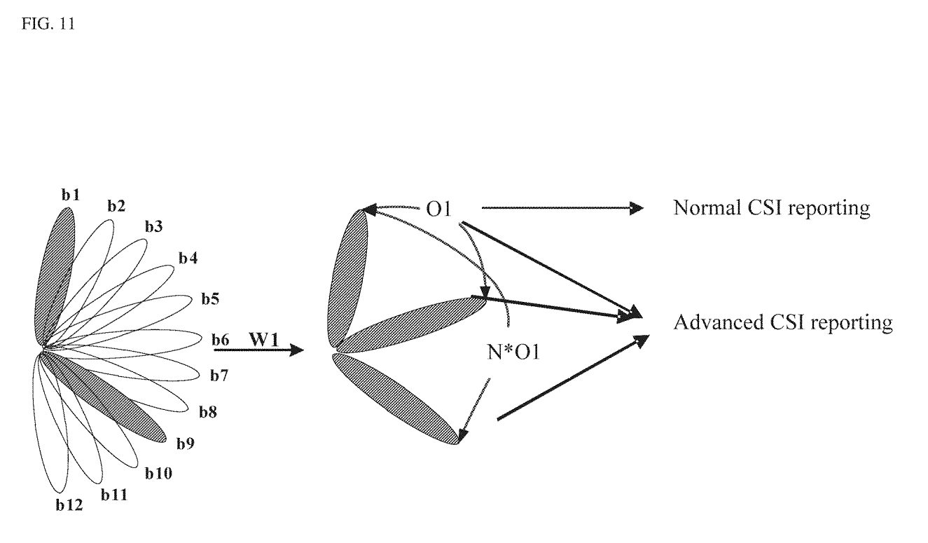

In FIG. 9, the BS 20 cannot predict which CSI will be chosen by the UE and cannot predict when to receive the CSI. A eNB will expect to receive a first part CSI (which contains a complete low resolution CSI) at subframe “n+4,” which also includes a CSI Type Indicator (CTI) for the advanced CSI.

One or more embodiments of the present invention may include one or more of the following advantages.

One or more embodiments of the present invention describe one way to construct codebook for channel matrix or precoder feedback. The codebook has a nested structure which can be used for channel quantization with multiple resolutions. Such a codebook design enables flexible tradeoff between channel quantization accuracy and feedback overhead. As the low resolution codebook part is built based on the legacy codebook, it fully follows the legacy feedback framework, and it achieves a good compatibility with the legacy UE, which can only support legacy codebook.

One or more embodiments of the present invention propose a hierarchical feedback framework to support normal CSI feedback and advanced CSI feedback. The feedback framework can support flexible tradeoff between channel feedback accuracy, feedback overhead and latency.

One or more embodiments of the present invention may avoid poor performance by low resolution feedback. One or more embodiments of the present invention may avoid unnecessary feedback overhead incurred by high resolution feedback. One or more embodiments of the present invention may avoid unnecessary channel feedback accuracy degradation caused by high resolution feedback calculation. One or more embodiments of the present invention may be used for eNB to obtain reliable channel state information to optimize beamforming and Multi-Input Multi-Output (MIMO) (e.g., SU-MIMO or MU-MIMO) to provide high data rate, high reliability service.

One or more embodiments of the present invention may differ in the way to construct codebook. That is, previous methods focus on designing new codebook for advanced CSI reporting, which is not compatible to the legacy LTE codebook, or reusing legacy codebook, with either non-orthogonal or constrained DFT beams. One or more embodiments of the present invention provide a method to construct high resolution beam by reusing legacy codebook of LTE. Besides, beams can be both constrained and unconstrained, orthogonal or non-orthogonal. Another difference of one or more embodiments of the present invention is the design of adaptive reporting type indication.

The above examples and modified examples may be combined with each other, and various features of these examples can be combined with each other in various combinations. The invention is not limited to the specific combinations disclosed herein.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. A method of constructing a codebook with multiple resolution in a wireless communication system comprising:
constructing, with a user equipment (UE), a high resolution codebook using a low resolution codebook; and
transmitting, from the UE to a base station (BS), Channel State Information (CSI) feedback in accordance with a feedback scheme corresponding to the high resolution codebook or the low resolution codebook.

2. The method according to claim 2, wherein the high resolution codebook defines the feedback scheme corresponding to the high resolution codebook.

3. The method according to claim 1, further comprising:
selecting, with the UE, multiple first beams from multiple second beams used for downlink transmission from the BS,
wherein the constructing constructs the high resolution codebook based on the multiple first beams, and
wherein the low resolution codebook is constructed based on a single beam selection scheme that selects a single beam.

4. The method according to claim 3, wherein the selecting selects the multiple first beams based on the low resolution codebook.

5. The method according to claim 3, wherein the selecting selects the multiple first beams based on a rank 1 beam selection scheme of a Long Term Evolution (LTE) standard.

6. The method according to claim 3, wherein the selecting selects the multiple first beams based on a rank 3 beam selection scheme of a LTE standard.

7. The method according to claim 3,
wherein the multiple first beams include a leading beam, and
wherein when a rank 1 codebook is used for a normal CSI feedback scheme, the leading beam is the same as a rank 1 beam used to construct the rank 1 codebook.

8. The method according to claim 7, wherein beams other than the leading beam in the multiple first beams are orthogonal to the leading beam.

9. The method according to claim 3,
wherein the multiple first beams include a leading beam, and
wherein when a rank 3 codebook is used for a normal CSI feedback scheme, the leading beam is the same as one of beams of a rank 3 codebook beam group to construct the rank 3 codebook.

10. The method according to claim 9, wherein beams other than the leading beam in the multiple first beams are beams other than the one of beams of the rank 3 codebook beam group.

11. The method according to claim 1, wherein the low resolution codebook reuses a legacy beam and a same beam selection scheme under a LTE standard.

12. The method according to claim 1, wherein the high resolution codebook reuses a rank 1 beam selection scheme or a rank 3 beam selection scheme of a LTE standard.

13. The method according to claim 12, wherein the high resolution codebook reuses the rank 1 beam selection scheme when beam selection has no group constrain.

14. The method according to claim 12, wherein the low resolution codebook reuses the rank 3 beam selection scheme when beam selection has group constrain.

15. The method according to claim 12, wherein the low resolution codebook reuses the rank 3 beam selection scheme when beam selection has no group constrain

16. The method according to claim 1, wherein the feedback scheme comprises a hierarchical feedback framework to support normal CSI feedback and advanced CSI feedback.

17. The method according to claim 1, further comprising:
notifying, with the BS, the UE of a CSI feedback type,
wherein the CSI feedback type indicates normal CSI feedback or advanced CSI feedback, and
wherein the transmitting transmits the CSI feedback in accordance with the CSI feedback type.

18. The method according to claim 17, wherein the normal CSI feedback and the advanced CSI feedback different feedback delays.

19. A user equipment (UE) comprising:
a processor that constructs a high resolution codebook using a low resolution codebook; and
a transmitter that transmits, to a base station (BS), Channel State Information (CSI) feedback in accordance with a feedback scheme corresponding to the high resolution codebook or the low resolution codebook.

20. The UE according to claim 19,
wherein the processor selects multiple first beams from multiple second beams used for downlink transmission from the BS,
wherein the processor constructs the high resolution codebook based on the multiple first beams, and
wherein the low resolution codebook is constructed based on a single beam selection scheme that selects a single beam.
